(19) United States
(12) Patent Application Publication
(10) Pub. No.: US 2006/0239310 A1
(43) Pub. Date: Oct. 26, 2006

(54) HIGH DEFINITION DIGITAL MEDIA DATA CABLE SYSTEM

(76) Inventor: David B. Salz, Cooper City, FL (US)

Correspondence Address: MALIN HALEY AND DIMAGGIO, PA, 1936 S ANDREWS AVENUE, FORT LAUDERDALE, FL, 33316, US

(21) Appl. No.: 11/380,104

(22) Filed: Apr. 25, 2006

Related U.S. Application Data
(60) Provisional application No. 60/594,622, filed on Apr. 25, 2005.

(51) Int. Cl. H01S 3/13

(52) U.S. Cl. 372/29.021

(57) ABSTRACT

The present invention provides a cable assembly and method of making thereof for use with HDMI/DVI connectors. The cable assembly of the present invention includes a flat extruded cable jacket that includes an oblong cross section. Parallel oblong orifices lie across the cross section of the extruded jacket, extend the length of the jacket and provide a means for the insertion of solid straight conductors extending through the oblong orifices. The alignment of the oblong orifices in conjunction with a cylindrical orifice provides a means to attach the conductors to a HDMI/DVI connector. The oblong configurations as associated with the present invention are also applicable for Firewire cable and provides for a flat cable assembly for use therein.

The application claims priority to Provisional Application Ser. No. 60/594,622 which was filed on Apr. 25, 2005.

### BACKGROUND OF THE INVENTION

1. Field of the Invention

The present invention relates generally to wire and cable systems and in particular to digital and multimedia applications, connectors, flat cables, housings and compatible components for providing superior audio and video performance. The novel cable system is extremely efficient and cost effective.

2. Description of the Prior Art

Conventional audio and video systems utilize twisted wire cables in large part, along with conventional terminals, banana plugs, snap-fit wire connectors and the like. Companies such as Monster Cable manufacture many such products, however they are of standard design, cables, terminations and plugs, and also utilize well know methods of attaching wires to plugs and connectors.

HDMI (High Definition Multimedia Interface) was the first industry-supported, uncompressed, all-digital audio/video interface. HDMI provides an interface between any audio/video source, such as a set-top box, DVD player, and A/V receiver and an audio and/or video monitor, such as a digital television (DTV).

HDMI supports standard, enhanced, or high-definition video, plus multi-channel digital audio on a single cable. It transmits all ATSC HDTV standards and supports 8-channel digital audio, with bandwidth to spare to accommodate future enhancements and requirements. Another video interface of concern includes Digital Visual Interface (hereinafter DVI) which provides a high-speed digital connection for visual data types that is display technology independent. One principal use of DVI includes providing connection between a computer and display device. Both HDMI & DVI have standardized specifications for industry use. The advantages of using HDMI are well known in the art principally due to its ability to carry high quality multi-channel audio data and carry all standard high definition consumer electrics video formats. The DVI connector is designed to co-exist with the standard VGA connector, however the latest in developments in the art have found the combination of use of the DVI & HDMI connectors for use in various consumer electronic devices.

HDMI & DVI both use standard connectors with round cables for connecting components. The round cables currently use twisted signal pairs, clock wire, drain wires and other connectors in a round cable that is covered by a shield and installation. Inherently, the manufacturing of the round cables includes the steps of twisting the wiring together. Skew errors occur with round cables due to length differentials caused by the twisting process. Also an assembly of connectors may be tedious due to the splicing requirements for attachment to the HDMI & DVI connectors. Use of the existing round cables encounter problems during installation and layout due to the inherent properties of the round cables and associated clearance issues.

Another notable cable application which uses a twisted or banded cable configuration includes Firewire IEEE 1394. Firewire typically consists of copper cable capable of carrying both data and power with associated software. Firewire enables the transmission of video and audio data in digital forms at high speeds reliably and is particularly used for connecting digital video devices to each other and to computers. Cable used under the Firewire standard also has similar drawbacks as described above in relation to cable use under the HDMI & DVI standards. Accordingly, current cables used in HDMI/DVI and Firewire applications include drawbacks related to both the manufacturing thereof and other drawbacks associates with the use thereof.

### SUMMARY OF THE INVENTION

The present invention provides a flat cable wire for superior HDMI and DVI interconnections, cable systems, audio and video quality and performance. The flat cable of the present invention used with proprietary connectors and housings transfers high bandwidth digital content and reduces losses and interference through an improved structure and interface.

The present invention optimizes equipment performance in terms of uncompressed digital audio and video for the highest quality, crisp images, and minimizes losses in transmission or signal degradation. The flat cable of the present invention is fully compatible with DVI and HDMI in all existing high definition formats (720p, 1080i and 1080p), and will accommodate future improvements in formats. Furthermore, the present invention also supports and enhances Firewire, IEEE 1394, USB and conventional technologies.

The flat cable layout of the present invention reduces the number of manufacturing steps, through the use of straight signal pairs, in place of the conventional twisted signal pairs and groupings. The design of the present invention also lines up the conductors with the appropriate plug contacts for more efficient assembly. The benefits include lower attenuation and crosstalk, reduced skew and superior impedance uniformity. Accordingly, the present invention provides for superior mechanical, electrical, acoustical and visual performance.

It is therefore an object of the present invention to provide a cable assembly for signal transmissions that includes an extruded jacket having an oblong cross section with a plurality of oblong orifices which extend the length of the jacket. A pair of solid straight conductors extend through each oblong orifice to provide a connection means for the cable assembly.

It is also an object of the present invention to provide a cable assembly for signal transmission that includes an extruded jacket having an oblong cross section where four oblong orifices extend the length of the jacket and are positioned substantially parallel across the oblong cross section. A cylindrical orifice also positioned to the right of the four oblong orifices and extends the length of the extruded jacket. The orifices are aligned in order to provide a efficient and effective HDMI/DVI connection.

It is yet another object of the present invention to provide a method of manufacturing a cable assembly including the steps of: molding a cable jacket which has an oblong cross section; fabricating oblong orifices extending the length of the jacket and aligning the oblong orifices in a parallel formation across the oblong cross section of the cable jacket where in the alignment facilitates connection to a HDMI/DVI connector.

### BRIEF DESCRIPTION OF THE DRAWINGS

FIG. 1 is a sectional perspective view of a prior art round HDMI & DVI cable.

FIG. 2 is a perspective view of a DVI connector and flat cable according to the present invention.

FIG. 3 is a perspective view of a HDMI connector and flat cable according to the present invention.

FIG. 4A is a sectional view of the HDMI/DVI cable according to the present invention.

FIG. 4B is a sectional view of the HDMI/DVI cable according to the present invention when the cables are shown.

FIG. 5A shows a sectional view of a prior art Firewire.

FIG. 5B depicts a sectional view of a flat cable Firewire according to the present invention.

FIG. 6 shows a cross section of a signal pair according to the present invention.

FIG. 7A shows a cut out view of the HDMI connection to the top side of HDMI connector.

FIG. 7B shows a cut out view of the HDMI connection to the bottom side of HDMI connector.

### DETAILED DESCRIPTION

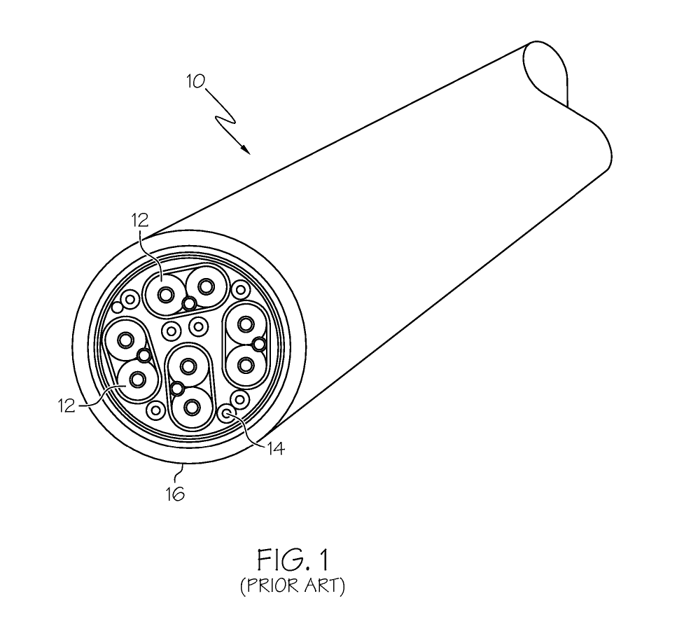

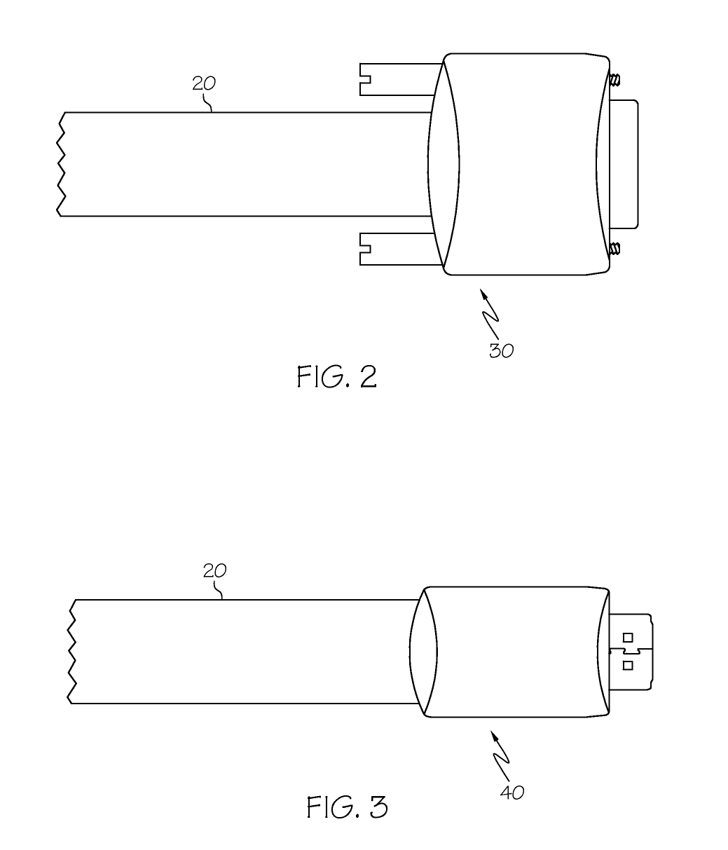

FIG. 1 shows a sectional view of a prior art HDMI/DVI cable. Cable 10 includes four signal pairs 12 and low frequency connectors 14 twisted within the shield 16 and insulation 18. Each signal pair 12 includes two conductors 13a, 13b and a drain wire 11. A grouping of signal pairs 12 and connectors 14 are twisted in a band through the length of cable 10. FIGS. 2 and 3 show prospective views of DVI connector 30 and HDMI connector 40. These prospective views show a flat cable 20 according to the present invention. Flat cable 20 leads into connectors DVI 30 and HDMI 40 in a manner as shown. The flat cable 20 of the present invention may provide higher performance than the round cable of the prior art, especially when transmission is over longer lengths. Further, during use the end user may conceal the flat cable 20 more easily as opposed to the round cable of the prior art.

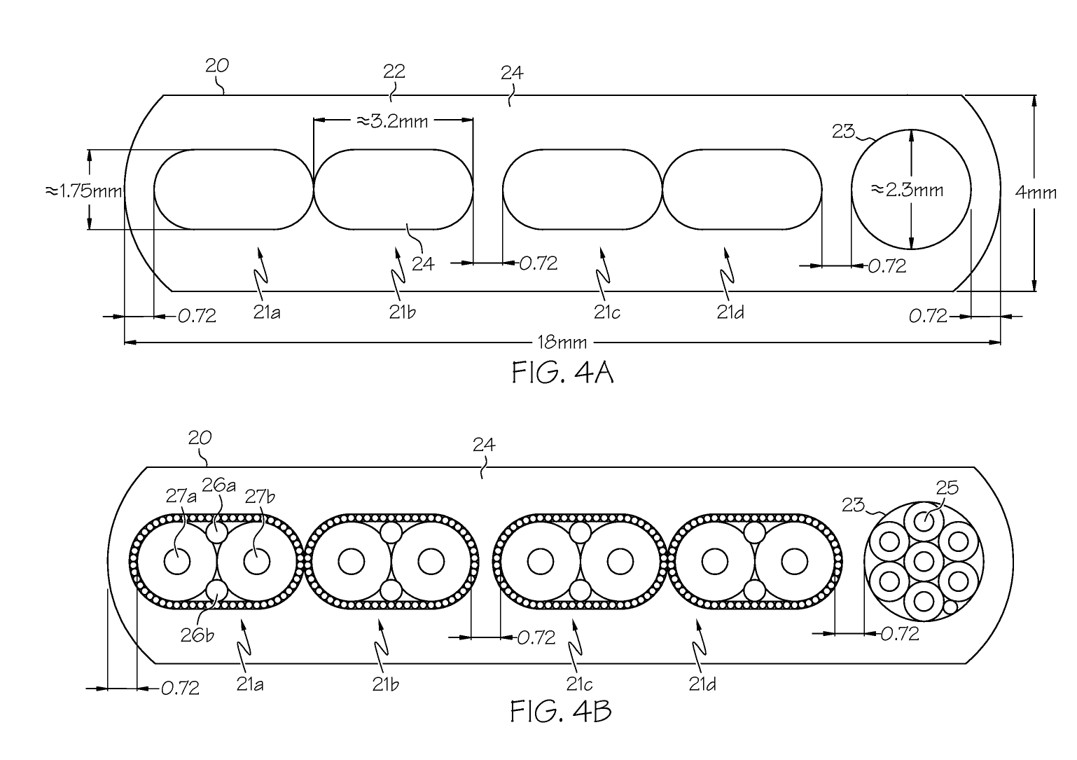

FIG. 4A shows a sectional view of the flat cable 20 according to present invention. As shown oblong orifices 21a, 21b, 21c, 21d are aligned and parallel within PVC jacket 24 which creates the insulating body for flat cable 20. The jacket 24 has a narrow oblong shaped cross section. In one exemplary embodiment, the width of the cross section is about 18 mm with a height of about 4 mm. Other embodiments of the present invention may include various dimensions of the cross sections to accommodate the particular application, i.e., widths may be reduced to about 10 mm or lower and the height may be reduced to about 2 mm. When the cable assembly is used with a HDMI connector the width of the cross section can vary up to 21 mm. As shown in FIG. 4A to the right of the oblong orifices 21 is a cylindrical orifice 23 provided for the insertion of the twisted group of low frequency copper conductors. In one exemplary embodiment, the cylindrical orifice 23 has a diameter of about 2.3 mm which allows for a sufficient number of conductors during use, although diameters may be adjusted in order to fit the dimensions of the extruded jacket. The orifices 21 may be surrounded by a metalized polyester foil 32 plus spiral copper strands 22 as shown in FIG. 6. Within the spiral strands 22 lies a second metalized polyester foil 29. The oblong orifices 21 are provided for insertion of conductors 27 and drain wires 26 which are shown in detail in FIG. 4B and FIG. 6. In one exemplary embodiment, the oblong orifices 21 have a width of 3.2 mm and a height of 1.75 mm, however these dimensions may be adjusted in order to fit the dimensions of the extruded jacket. The oblong orifices may be positioned across the cross section using four orifices as shown, where the first orifices 21a is placed 0.72 mm from the left edge of the cable jacket 24. The first orifices 21a and the second orifice 21b are substantially adjacent to one another, however 0.72 mm of spacing is placed between orifice 21b and orifice 21c. The third oblong orifice 21c is substantially adjacent to orifice 21d.

The configuration of flat cable 20 with the alignment of the oblong orifices 21 and the cylindrical orifice 23 provide for the novel configuration of the flat cable 20 according to the present invention. FIG. 4B shows flat cable 20 where conductors have asserted through the orifices 21a, 21b, 21c, 21d and cylindrical orifice 23. Eight solid conductors are fed through flat cable 20 as four signal pairs as shown in FIG. 4B. Insulation 28a, 28b surrounds conductors 27a, 27b and foil 29 surrounds the conductors 27a, 27b where finally the spiral strands 22 surrounds the foil 29. The spacing of the conductors 27, orifices 21 and orifice 23 is conducive for connection into the HDMI or DVI connectors according to industry standards. Advantageously, the conductors 27a, 27b lay flat and straight through out flat cable 20 and therefore eliminates drawbacks associated with the prior art. The flat conductors eliminate the need for twisting during manufacturing and provide an efficient method to connect the flat cable to HDMI/DVI connectors.

FIG. 6 shows a detail of signal pair conductors as used in flat cable 20. The solid conductors 27a, 27b are surrounded by insulation within the orifice 21. As previously discussed, polyester foil 32 plus spiral strands 22 surround the outer edge of orifice 21 and within spiral strands 22 lies foil 29. Also within the foil 29 lies drain wires 26a, 26b. Although two drain wires are shown in the exemplary embodiment one drain wire may be used or more than two may be inserted through the foil 29 as so desired. The conductors, drain wires and spiral shield may be manufactured using silver plated oxygen-free copper, however other materials may be used that may be suitable for HDMI/DVI cables.

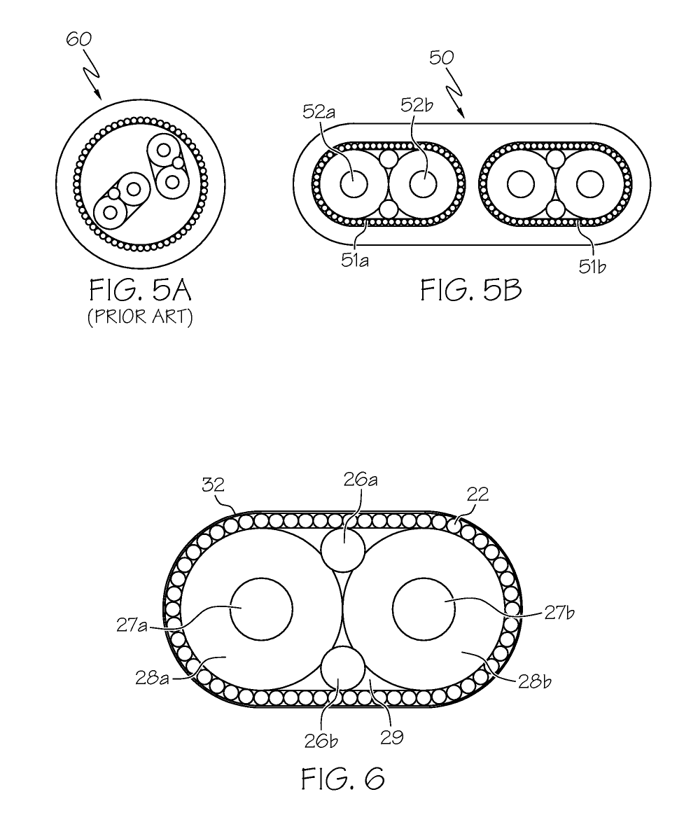

FIG. 5A shows existing prior art related to a Firewire cable. Similar to the existing prior art for HDMI/DVI cable, Firewire includes signal paired conductors twisted in a round formation along with low frequency conductors and drain wires to form a round cable configuration. FIG. 5B shows a cross section of a flat cable 50 which depicts a Firewire according to the present invention. Firewire 50 of FIG. 5B includes two oblong orifices 51a, 51b aligned in a parallel formation as shown. The conductors 52a, 52b within Firewire cable 50 lie flat as opposed the prior art of FIG. 5A which are twisted in any manner throughout the length of the cable 60. The conductors, insulation, drain wires, spiral strands, and polyester foil are similar to the detailed layout of FIG. 6. The flat cable 50 maintains an oblong cross section conducive for the fabrication of orifices 51a, 51b.

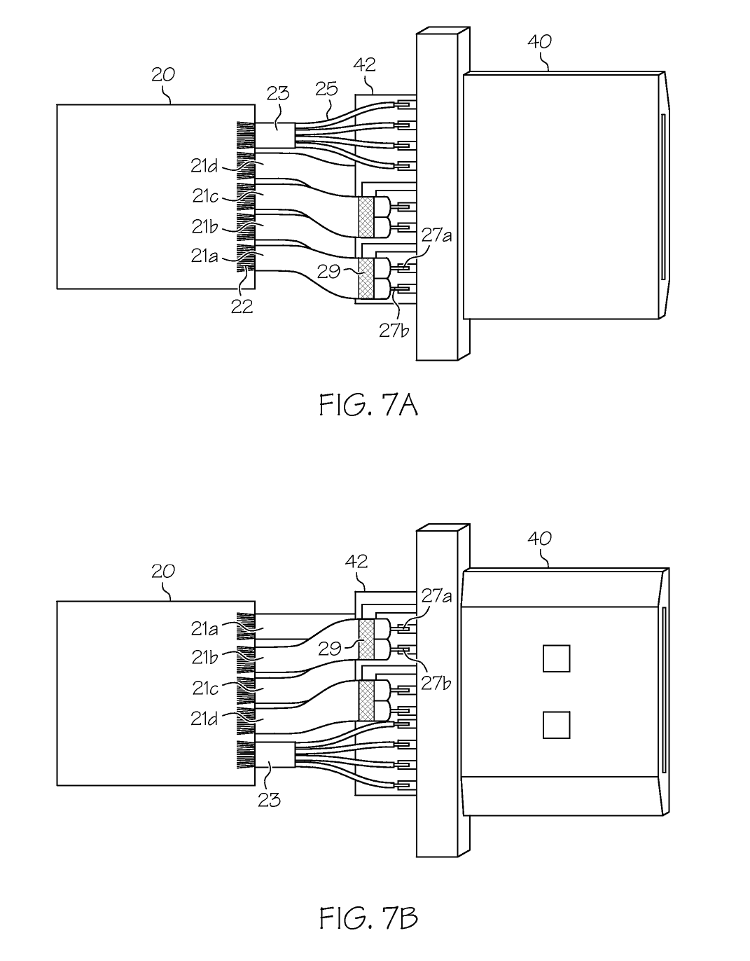

FIGS. 7A and 7B show a cut out view of the connection of flat cable 20 to a HDMI connector 40. The individual cables 28a, 28b have been spliced to expose conductors 27a, 27b. As shown, the PVC jacket 24 has been spliced to expose the signal pairs wrapped in foil 29 and the low frequency conductors 25. Spiral strands 22 have been spliced as shown and pealed back to expose the foil shield 29. The solid SPC conductors 27a, 27b of the signal pairs have been connected to connection plate 42 of the HDMI connector 40 as shown. Once the signal pairs are spliced to expose conductors 27a, 27b, they may be easily connected to connection plate 42 as shown. The configuration of flat cable 20 therefore not only assists in the use of the cable by the end user, it helps to create efficient and less costly manufacturing procedure for the flat cable connection to the HDMI connectors 40 as shown in FIG. 7.

What is claimed is:

1. A cable assembly for signal transmissions comprising:
a. an extruded jacket having an oblong cross section, where said cross section has a width of at least 10 mm and a height of at least 2 mm;
b. a plurality of oblong orifices which extend the length of the jacket where said oblong orifices are substantially parallel across the oblong cross section, where each said orifice has a width of at least 1.5 mm and a height of at least 0.8 mm; and
c. a pair of solid straight conductors extending through each oblong orifice.

2. The cable assembly according to claim 1, wherein the plurality of oblong orifices is limited to a total of four.

3. The cable assembly according to claim 2, wherein the first oblong orifice is positioned at least 0.5 mm from a first edge of the cross section and adjacent to the second oblong orifice, wherein at least 0.5 mm of spacing lies between the second oblong orifice and the third oblong orifice, and wherein the third oblong orifice and the forth oblong orifice are adjacent.

4. The cable assembly according to claim 3, wherein the extruded jacket further includes a cylindrical orifice with at least a 1.0 mm diameter.

5. The cable assembly according to claim 4 wherein the cylindrical orifice is at least 0.5 mm from the edge of the forth oblong orifice.

6. The cable assembly according to claim 1 wherein each conductor includes at least 0.6 mm of insulation surrounding the conductors.

7. The cable assembly according to claim 6, wherein metalized polyester foil covers the insulation within the oblong orifice, spiral strands surrounds the polyester foil, and another layer of metalized polyester foil covers the spiral strands.

8. A cable assembly for signal transmissions comprising:
a. an extruded jacket having an oblong cross section, where said cross section has a width of about 18 mm and a height of about 4 mm;
b. four oblong orifices which extend the length of the jacket, where said oblong orifices are substantially parallel across the oblong cross section, where each said orifice has a width of about 3.2 mm and a height of about 1.75 mm, wherein the first oblong orifice is positioned about 0.72 mm from a first edge of the cross section and adjacent to the second oblong orifice, wherein about 0.72 mm of spacing lies between the second oblong orifice and the third oblong orifice, and wherein the third oblong orifice and the forth oblong orifice are adjacent; and
c. a cylindrical orifice extending the length of the jacket, where said cylindrical orifice has a diameter of about 2.3 mm wherein the cylindrical orifice is about 0.72 mm from the edge of the forth oblong orifice.

9. The cable assembly according to claim 8 further including:
a. a pair of solid straight conductors extending through each oblong orifice where the conductors are aligned for connection to a HDMI/DVI connector, where said conductors are surrounded by insulation.

10. The cable assembly according to claim 9 further including:
a. metalized polyester foil surrounding the insulation of the conductors;
b. copper spiral strands surrounding the foil; and
c. another layer of polyester foil surrounding the spiral strands;
d. at least one drain wire within the foil extending the length of the cable assembly.

11. The cable assembly according to claim 9, further including a plurality of conductors extending through the cylindrical orifice.

12. A method of manufacturing a cable assembly comprising the steps of:
a. extruding a cable jacket where the cable jacket has a oblong cross section, where said cross section having a width of at least 10 mm and a height of at least 2 mm;
b. fabricating oblong orifices extending the length of the jacket, where each said orifice has a width of at least 1.5 mm and a height of at least 0.8 mm; and
c. aligning the oblong orifices in a parallel formation across the oblong cross section of the cable jacket, where the alignment facilitates connection to a HDMI/DVI connector.

13. The method according to claim 12 wherein step of aligning includes:
a. creating four oblong orifices
b. placing the first oblong orifice about 0.5 mm from a first edge of the cross section and adjacent to the second oblong orifice, and
c. placing the third oblong orifice about 0.5 mm from the second oblong orifice and adjacent to the forth oblong orifice.

14. The method according to claim 12 further comprising the steps of
a. lining the oblong orifices with metalized polyester foil and copper spiral strands; and
b. extending a pair of solid straight conductors through each oblong orifice.

15. The method according to claim 13 further including the step of fabricating a cylindrical orifice extending the length of the jacket, where said cylindrical orifice has a diameter of about 2.3 mm.

16. The method according to claim 15 further including the step of:
a. positioning the cylindrical orifice about 0.5 mm from the fourth oblong orifice.

17. The method according to claim 14 further includes the steps of:
a. surrounding the conductors with at least 0.6 mm of insulation;
b. placing metalized polyester foil around the exterior of the insulation; and
c. extending at least one drain wire through the foil.

18. A cable assembly for signal transmissions comprising:
a. an extruded jacket having an oblong cross section;
b. a plurality of oblong orifices which extend the length of the jacket where said oblong orifices are substantially parallel across the oblong cross section; and
c. a pair of solid straight conductors with insulation extend through each oblong orifice; and
d. a foil means along with spiral strands surround the insulation within each oblong orifice.

19. A cable assembly for signal transmissions comprising:
a. an extruded jacket having an oblong cross section;
b. a plurality of oblong orifices which extend the length of the jacket where said oblong orifices are substantially parallel across the oblong cross section; and
c. a cylindrical orifice which extends the length of the jacket, where said cylindrical orifice is substantially parallel to the plurality of oblong orifices.
